(19) United States
(12) Patent Application Publication
(10) Pub. No.: US 2004/0032333 A1
(43) Pub. Date: Feb. 19, 2004

(54) Personal security wrist band

(76) Inventor: Alfred Thomas Hatt, Austin, TX (US)

Correspondence Address: Christopher J. Whewell, Western Patent Group, 6020 Tonkowa Trail, Georgetown, TX, 78628, US

(21) Appl. No.: 10/426,537

(22) Filed: May 1, 2003

Related U.S. Application Data
(60) Provisional application No. 60/404,455, filed on Aug. 19, 2002.

(51) Int. Cl. G08B 13/00

(52) U.S. Cl. 340/574; 340/573.1

(57) ABSTRACT

Provided herein is a personal security device in the form of a wrist band, which is intended to be worn about a limb of a wearer, such as a wrist. A device according to the invention is adapted to be secured in locked fashion about its wearer, and includes an alarm means which may be activated by the user at any desired time, to emit a high intensity audible alarm for a pre-determined amount of time to attract attention of other persons in the immediate vicinity for cases where the wearer perceives they are being approached by a would-be offender or attacker. According to a preferred embodiment, a radio frequency transmission is commenced simultaneously with the sounding of the audible alarm, in order to enable a second person who is possessed of a unit capable of receiving the transmitted signal to track and locate the person wearing the device of the invention.

This application claims the benefit of U.S. Provisional Application No. 60/404,455 filed Aug. 19, 2002, the entire contents of which are herein incorporated by reference.

### TECHNICAL FIELD

The present invention relates generally to security devices. In particular, the present invention provides a security band which is intended to be worn about a limb of the user to thwart attackers and to optionally provide a locator means.

### BACKGROUND

Often a child or other person will become separated from a supervising individual. The separation of a child or other person from a supervising individual can pose a serious threat to the safety and well-being of the child, especially in the presence of an attacker. As a consequence, there exists a demand for a child protection system which aids in preventing a child from being abducted by an attacker.

Child monitoring systems are well-known and are commonly used in the art to monitor the location of a child. One type of child monitoring system operates as a radio beacon detector which monitors the separation distance between a guardian and a child. If the distance between the guardian and the child exceeds a predetermined range, an alarm condition is established.

U.S. Pat. No. 5,689,240 provides a child monitor system that transmits and receives signals comprising a master unit and a remote unit, wherein a separation distance between the master unit and remote unit is continuously monitored and an alarm is activated on the master unit when no signal is received from the remote unit for at least a time longer than a preset interval. If the separation distance between the master and remote unit is exceeded for a time longer than a preset time interval, the remote unit activates an alarm attached to the remote unit. The master unit may also be used to activate manually the remote unit's alarm. A pin or key arrangement is provided that ensures that the remote unit is not deactivated without interfacing with the master unit.

U.S. Pat. No. 5,646,593 discloses a child proximity detection unit that includes two transceivers which communicate messages with one another.

U.S. Pat. No. 5,617,074 discloses a child finder that basically consists of a transmitter which is concealingly attachable to a child's body and which sends a signal to a conventional receiver so that the child's location can be continually monitored. The transmitter will typically be carried in an article of jewelry, such as a watch, bracelet, ring, or the like, and will use a special on/off switch which allows the transmitter to be activated only when the jewelry is being worn by the child. The switch includes a reciprocal push button which closes the transmitter's electrical circuit when depressed, and the button is spring-biasedly moved away from electrical contact with the transmitter's circuit when the article of jewelry is not being worn. To protect against inadvertent partial movement of the button which could break electrical contact thus deactivating the transmitter an electrical contact surface of the button is provided with an upwardly extending electrically conductive spring finger which maintains continual electrical contact irrespective of temporary and inadvertent reciprocal movement of the push button. When the push button is totally depressed, the spring finger recedes into a provided groove on the electrical contact surface of the button so as to prevent the finger from causing interference between the primary electrical contact surfaces.

Another type of child monitoring system operates as a remote controlled device which alarms passersby of the separation of a guardian and a child. Specifically, the guardian typically has a transmitter which, when activated, sends out an encoded radio signal. The child is typically wearing a monitoring unit which detects the encoded radio signal and, in turn, activates a loud siren. The siren notifies passerbys that the child has been separated from the parent and/or that the child is accompanying an unauthorized individual.

U.S. Pat. No. 5,640,147 teaches a system for monitoring the activity of a child comprising a monitoring and control means for transmitting at least one system-enabling signal and for receiving audio signals; and a child-mountable means for transmitting in response to the receipt of at least one of said system-enabling signals any audio detected in the immediate proximity to said child.

Other patents of interest include U.S. Pat. Nos. 5,661,460; 5,661,459; 5,557,259; 5,423,574; and 5,357,254. All patents mentioned are incorporated by reference thereto.

Child monitoring systems as described above typically suffer from at least one of the following drawbacks. As a first drawback, child monitoring devices are typically constructed as a bracelet or belt which can be easily fit onto and removed off of a child. Accordingly, it has been found that any unauthorized adult can easily remove the device from the child and thereby eliminate its usefulness. As a second drawback, child monitoring devices are typically remotely controlled using radio frequency signals. Accordingly, it has been found that radio frequency signals have a limited time of usage when a constant electrical drain is applied to the batteries in the remote device.

### SUMMARY OF THE INVENTION

It is an object of the present invention to provide a new and improved child protection device.

It is another object of the present invention to provide a child protection device which can be fitted onto a child.

It is yet another object of the present invention to provide a child protection device of the type described above which cannot be easily removed from the child or easily tampered with by an unauthorized person.

It is still another object of the present invention to provide a child protection device of the type described above which includes a sonic transducer which can emit a high intensity or loud sound alarm, at the desire of the wearer.

It is another object of the present invention to provide a child protection device of the type described above wherein the device is capable of sending a radio frequency signal to help in providing the location of the wearer to a person having a signal-receiving means component.

It is yet another object of the present invention to provide a child protection device as described above which has a limited number of parts, which is inexpensive to manufacture and which is easy to use.

The present invention provides a personal security wrist band that is designed to fit about a limb of the user which comprises: a) a band portion having an outer surface and a hollow interior space adapted to house electrical and mechanical components; b) a push-button switch disposed on said outer surface; c) a battery compartment adapted to receive electrical storage batteries disposed within said hollow interior space; d) a sound transducer disposed within said hollow interior space sufficiently to enable sonic energy emitted by said transducer to be broadcast into the area about said wrist band; and e) a circuit means in sufficient electrical contact with said switch, one or more batteries disposed within said battery storage compartment, and said transducer for enabling a sound to be emitted when said switch is depressed. According to a preferred form of the invention the band portion of a personal security wrist band according to the invention is comprised of: a) a first semi-circular half portion having a first end portion and a second end portion; and b) a second semi-circular half portion, having a first end portion and a second end portion. The first end portion of the first semi-circular half portion and the first end portion of the second semi-circular half portion are pivotally connected to one another by a hinge means. According to a preferred form of the invention, the second end portion of the first semi-circular half portion includes a notched tang portion, and the second end portion of the second semi-circular half portion includes a notched tang receiver. The receiver is adapted to receive the notched tang portion. According to another preferred form of the invention is provided a wrist band which further comprises a locking means disposed within the hollow interior space of the second semi-circular half portion that is located in sufficient proximity to the notched tang receiver to provide selective locking of the notched tang portion within said notched tang receiver. Preferably, a keyhole is disposed on the outer surface portion of the second semi-circular half portion that is adapted to receive a key for actuating said locking means. According to a preferred form of the invention the circuit means includes a delay sufficient to cause a sound to be emitted from the transducer for any time period in the range of between about 1 and 20 minutes and subsequently causes the sound to cease until the switch is again depressed. According to yet another preferred form of the invention there is a protective means disposed on the surface portion, which protective means comprises a wire mesh, wherein the wire mesh is disposed about the portion of the transducer which emits sound, so as to protect the transducer from damage from impacts, droppage, and normal wear and tear.

An alternate form of the invention is a wrist band as aforesaid, wherein the circuit means includes a transmitting means. Preferably, the transmitting means transmits a radio frequency signal after said switch is depressed.

The present invention also comprises a system for locating a person which comprises a wrist band according to any of the aforesaid embodiments and a signal-receiving means, wherein the signal-receiving means includes at least one indicator means selected from the group consisting of: a light emitting means and a sound emitting means. It is preferred that the indicator means increases in its intensity as the distance between said wrist band and said signal-receiving means decreases.

One advantage of a wrist band according to the invention over the prior art is that the alarm feature which includes the sound transducer only draws current from the battery(ies) when it is activated, which is done so selectively by the user. This greatly prolongs the life of the battery(ies) and renders a device according to the invention useful over a greater time span on the same batteries over prior art devices.

### BRIEF DESCRIPTION OF DRAWINGS

In the annexed drawings:

FIG. 1 is a side view of a wrist band according to one embodiment of the invention;

FIG. 2 is a side view of a wrist band according to another embodiment of the invention

FIG. 3 is a top view of a wrist band according to yet another embodiment of the invention;

FIG. 4 is a bottom view of a wrist band according to yet another embodiment of the invention;

FIG. 5 is a bottom view of a wrist band according to yet another embodiment of the invention;

FIG. 6 is a perspective view of a signal-receiving means according to one embodiment of the invention.

### DETAILED DESCRIPTION

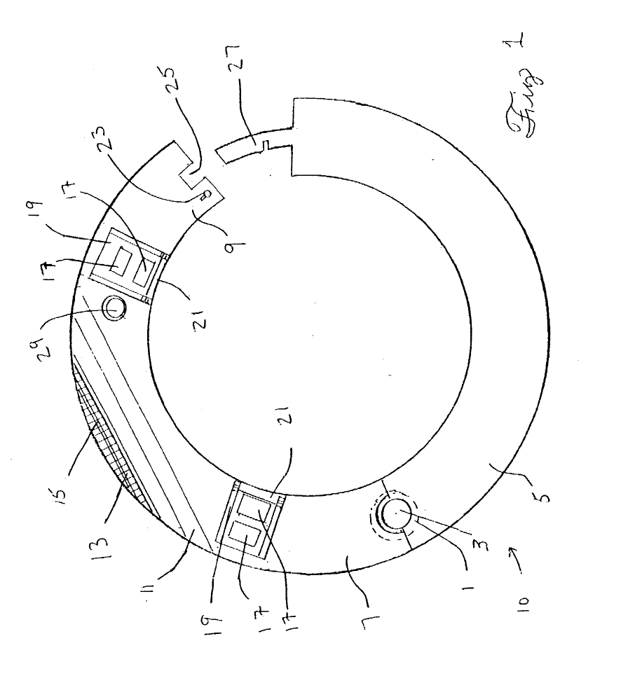

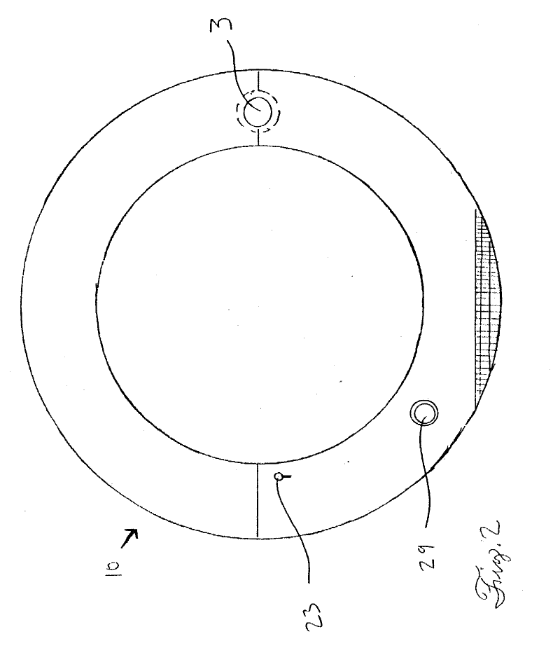

Referring to the drawings and initially to FIG. 1 there is shown a wrist band 10 according to one form of the invention in an open position. In this embodiment, the wrist band is comprised of a first semi-circular half portion 5 and a second semi-circular half portion 7, which are connected at their first end portions by a hinge means 3 which is preferably covered by a cap 1 to shield the hinge from dust and dirt, etc. There is at least one battery storage compartment 19 into which are housed electrical storage batteries 17, and preferably the unit has a second battery storage compartment as well. The battery storage compartment 19 includes an access panel 21 which prevents the battery(ies) from falling out of the unit.

Each of the semi-circular half portions include a hollow interior space in which may be housed various components, which include an electronics circuit board 11, and a sound transducer 13 that is recessed from the surface of the wrist band, which transducer functions by emitting a sound. The transducer is protected from damage by a wire screen or mesh 15 disposed above its top surface. There is a push-button switch 29, which is in effective electrical contact with the battery(ies), sonic transducer, and electronic circuitry such that when the push-button switch is depressed, a high pitched sound is emitted from the sonic transducer, thus alerting persons in the area of the occurrence of the pressing of the button, which is intended to focus the attention of persons nearby to the person who is wearing a wrist band according to the invention. This is intended to prevent an attacker from carrying out an intended improper deed by alerting nearby persons.

There is a notched tang 27 disposed on the second end portion of the first semi-circular half portion 5, and a notched tang receiver 25 disposed on the second end portion of said second semi-circular half portion 7. The receiver 25 is adapted to receive the notched tang portion, and in conjunction with a locking means 9 that is actuatable by a key inserted into keyhole 23 disposed within the hollow space ensures that a wrist band according to the invention can be secured to the limb of a wearer without worry of its being removed by an attacker or during the course of the wearer's normal activities.

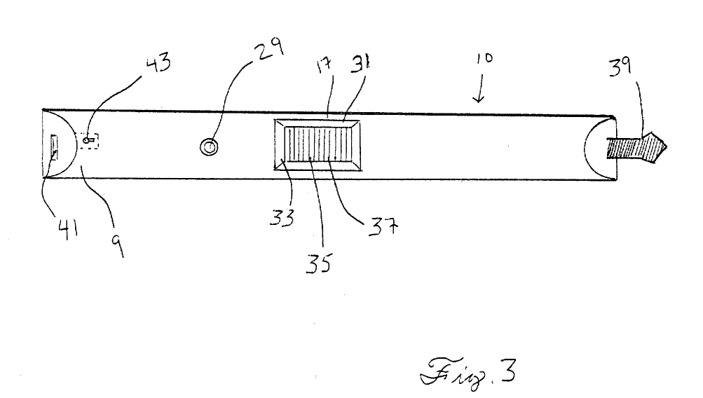

FIG. 2 shows a wrist band 10 according to the invention in its closed, locked position.

FIG. 3 shows the top view of a wrist band 10 according to an alternate form of the invention, which wrist band is of a singular construction, as being made from a single strap of a flexible material such as leather, woven nylon, cotton or other fibers, or wire mesh (hereinafter collectively “flexible material”). Such a wrist band comprises a first end portion having a locking tang 39, and a second end portion having a locking tang receiver 41, and a locking means 9 which includes a keyhole 43. There is a push button switch 29, a sonic transducer 35 which is protected by a wire mesh 33, and an antenna means 37. Preferably, the circuitboard 11 and batteries are embedded beneath the transducer 35

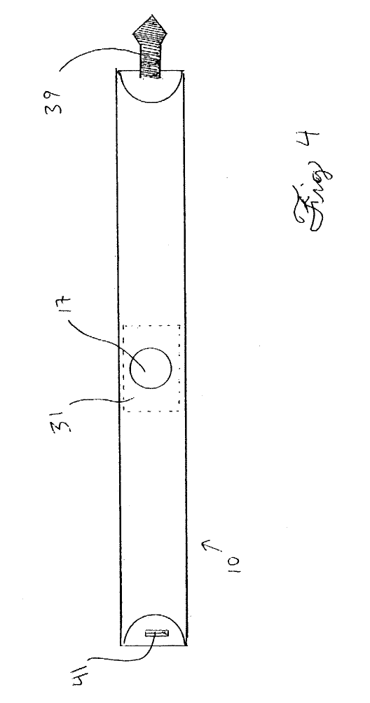

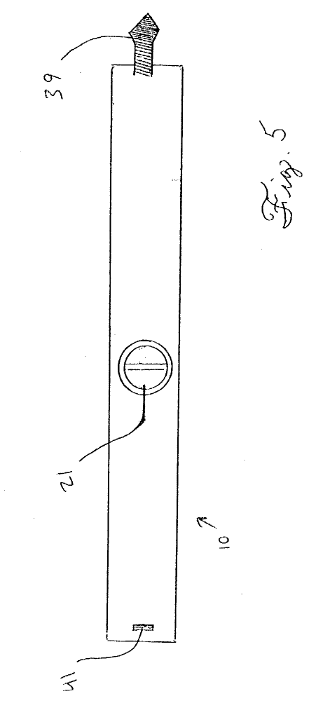

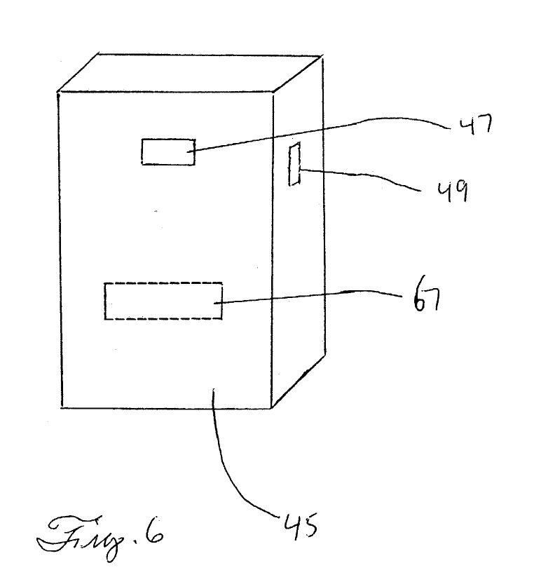

FIG. 4 shows a bottom view of the wrist band that was shown in FIG. 3, and more clearly depicts the locations of the circuit board 31 and battery(ies) 17, wherein the circuitboard is preferably disposed between the battery(ies) and the sound transducer 35 (FIG. 3).

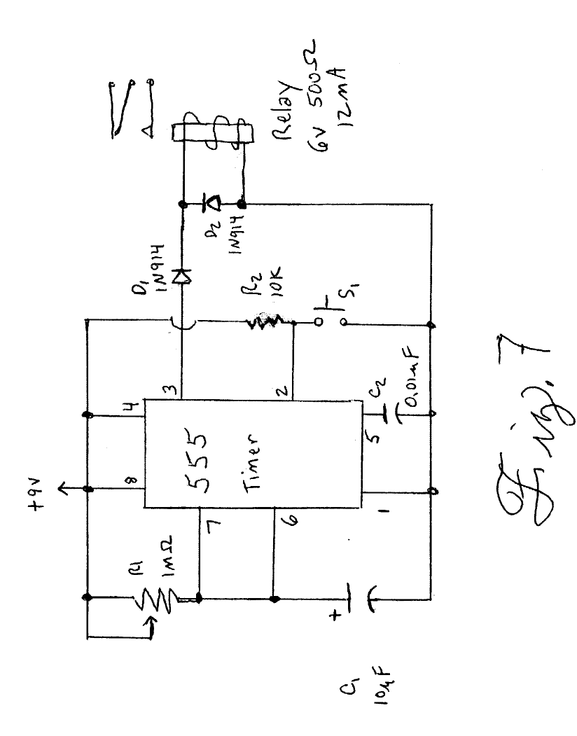

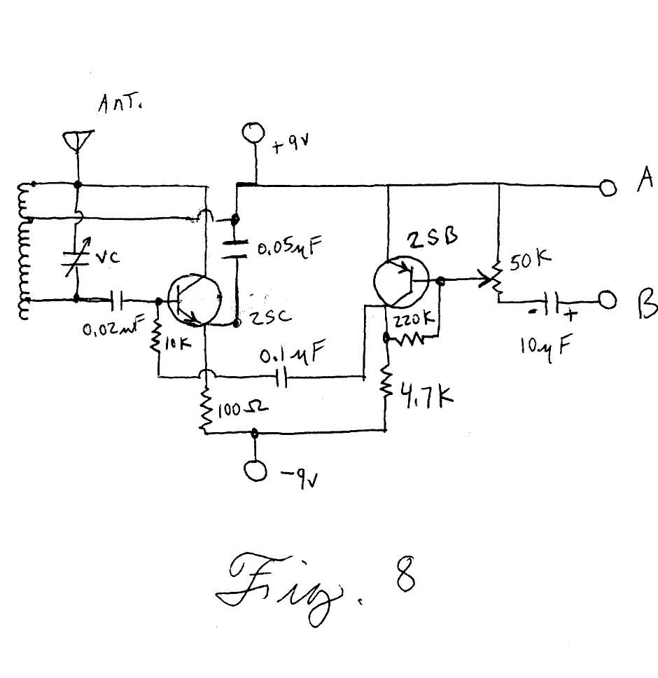

FIG. 5 shows the battery compartment access cover 21 on a wrist band according to an alternate form of the invention.

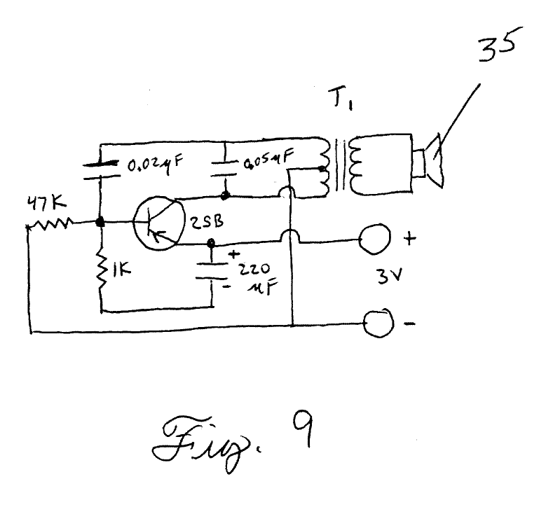

FIG. 6 shows a signal-receiving means 45 according to a system of the invention, having a means for holding storage battery(ies) 67, an on/off switch 49, and a lamp indicator 47.

FIG. 7 shows an example of one timing circuit useful in accordance with the present invention, wherein closing switch 29 (S1 in FIG. 7) momentarily begins a timing cycle. The relay is actuated during the entire cycle, and it is in the relay circuit that the sonic transducer 35 is in series with a battery 17. Thus, the sonic transducer emits its audible sound during the entire cycle of the timing circuit of FIG. 7. The amount of duration of the audible signal is controlled by R₁ and C₁. C₂ prevents false triggering, and D₂ absorbs voltage generated by the relay coil when the relay is switched off. Such timing circuitry is well-known in the art, and the present invention is not intended to be limited to the circuitry provided by this single example, but rather embraces the use of all well-known timing circuitry in the prior art as an electronic timing means.

FIG. 8 shows an example of one possible transmission means for transmitting a radiofrequency signal in accordance to a preferred embodiment of the invention. Although the circuit represented by the schematic diagram of FIG. 8 is capable of modulating a signal inputted to poles labeled A and B, in the range of about 1 MHZ, such as from a sound generator as described schematically in FIG. 9, the prior art is replete with such transmitting circuitry. The present invention is intended to include the use of any circuitry of the prior art which is known to those skilled in the art as capable of emitting an rf signal as a transmitting means useful as an element of a device according to the present invention. Similarly, the unit for receiving the signal is versatile in its possible use of circuitries of varied design, being limited only to those receivers known in the art to be useful for receiving rf signals of various frequencies. It is preferred that a system according to the invention employ rf energy having frequencies high enough so as to minimize interference from other transmissions. Thus, the most preferred rf energy for use with the present invention is in the range of 1 GHz to about 40 GHz, including every frequency therebetween.

FIG. 9 shows a schematic representation of a circuit capable of outputting an alarm signal to a sound transducer 35. The circuit consists basically of an oscillator and an output transformer, wherein the output transformer is connected directly to the sonic transducer 35. Oscillator circuits are well-known in the art, and the present invention contemplates the use of all known oscillators for producing sounds of varied pitch and intensity when used as a component of the circuitry of the present invention. Thus the present invention should not be construed as being limited in its employment of known means by which the sonic transducer is driven.

As used herein, the words “sonic transducer” means any device capable of converting an electrical impulse into sound energy that is in the range capable of being received by the human ear or from about 20 to 20000 cycles per second. Thus, sonic transducers include without limitation buzzers, piezoelectric devices, and ordinary speakers.

The present invention employs a locking means to secure a device according to the invention about the limb of a wearer. Any locking means known in the prior art may be used provided it is capable of maintaining the locking tang into its receiver and preventing the removal of a device of the invention without the use of a key including warded locks and pin and tumbler types. The locking means is preferably, a ward locking means.

Various flexible materials have been indicated as being useful for providing a device according to the invention when the band is of singular construction. For cases as in the embodiment of FIG. 1, the preferred material of construction is a pure metal or a metallic alloy. Included within this class, without limitation are the metals: steel, titanium, copper, brass, gold alloys, and silver. This choice is for strength and the most preferred material of construction is brass. However, other materials such as polymers, polymeric composites, and reinforced composites may be used, in addition to woods.

The battery(ies) utilized in the invention may be any electrical storage device known, including nickel-cadmium cells, mercury batteries, lithium hydride batteries, nickel metal hydride batteries, et al, as many batteries are known to the electrochemist. It is preferred that the batteries employed in the present invention be as small as possible whilst having a high amp hour rating to enable maximized use of the device.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

I claim:

1) A personal security wrist band that is designed to fit about a limb of the user which comprises:
a) a band portion having an outer surface and a hollow interior space adapted to house electrical and mechanical components;
b) a push-button switch disposed on said outer surface;
c) a battery compartment adapted to receive electrical storage batteries disposed within said hollow interior space;
d) a sound transducer disposed within said hollow interior space sufficiently to enable sonic energy emitted by said transducer to be broadcast into the area about said wrist band;
e) a circuit means in sufficient electrical contact with said switch, at least one battery disposed within said battery storage compartment, and said transducer for enabling a sound to be emitted when said switch is depressed.

2) A personal security wrist band according to claim 1 wherein said band portion is comprised of a first semi-circular half portion having a first end portion and a second end portion; and a second semi-circular half portion, having a first end portion and a second end portion, wherein said first end portion of said first semi-circular half portion and said first end portion of said second semi-circular half portion are pivotally connected to one another by a hinge means.

3) A wrist band according to claim 2 wherein said second end portion of said first semi-circular half portion includes a notched tang portion.

4) A wrist band according to claim 3 wherein said second end portion of said second semi-circular half portion includes a notched tang receiver, which receiver is adapted to receive said notched tang portion.

5) A wrist band according to claim 4 further comprising a locking means disposed within said hollow interior space of said second semi-circular half portion that is located in sufficient proximity to said notched tang receiver to provide selective locking of said notched tang portion within said notched tang receiver.

6) A wrist band according to claim 5 and further comprising a keyhole disposed on the outer surface portion of said second semi-circular half portion that is adapted to receive a key for actuating said locking means.

7) A wrist band according to claim 1 wherein said circuit means includes a delay sufficient to cause a sound to be emitted from said transducer for any time period in the range of between about 1 and 20 minutes and subsequently causes said sound to cease until said switch is again depressed.

8) A wrist band according to claim 1 further having a protective means disposed on said surface portion which protective means comprises a wire mesh, wherein said wire mesh is disposed about the portion of said transducer which emits sound, so as to protect said transducer from damage from impacts, droppage, and normal wear and tear.

9) A wrist band according to claim 1 wherein said circuit means includes a transmitting means for transmitting a radio-frequency signal.

10) A wrist band according to claim 9 wherein said transmitting means transmits a radio frequency signal after said switch is depressed.

11) A system for locating a person comprising:
a) a wrist band according to claim 10;
b) a signal-receiving means,
wherein said signal-receiving means includes at least one indicator means selected from the group consisting of: a light emitting means and a sound emitting means, and wherein said indicator means increases in its intensity as the distance between said wrist band and said signal-receiving means decreases.

12) A personal security wrist band that is designed to fit about a limb of the user which comprises:
a) a band portion made from a flexible material having a first end portion and a second end portion, and surface portion;
b) a push-button switch disposed on said outer surface;
c) a battery compartment adapted to receive electrical storage batteries, disposed between said first end portion and said second end portion;
d) a sound transducer disposed between said first end portion and said second end portion;
e) a circuit means in sufficient electrical contact with said switch, at least one battery disposed within said battery storage compartment, and said transducer for enabling a sound to be emitted when said switch is depressed.

13) A wrist band according to claim 12 wherein said first end portion of said band includes a locking tang portion.

14) A wrist band according to claim 13 wherein said second end portion of said band includes a locking tang receiver, which receiver is adapted to receive said locking tang portion.

15) A wrist band according to claim 14 wherein said receiver includes a locking means for locking said locking tang in a fixed position inside said receiver, wherein said locking means includes a keyhole.

16) A wrist band according to claim 12 wherein said circuit means includes a delay sufficient to cause a sound to be emitted from said transducer for any time period in the range of between about 1 and 20 minutes and subsequently causes said sound to cease until said switch is again depressed.

17) A wrist band according to claim 12 further having a a wire mesh disposed about the portion of said transducer which emits sound, so as to protect said transducer from damage from impacts, droppage, and normal wear and tear.

18) A wrist band according to claim 12 wherein said circuit means includes a transmitting means.

19) A wrist band according to claim 18 wherein said transmitting means transmits a radio frequency signal after said switch is depressed.

20) A system for locating a person comprising:
a) a wrist band according to claim 19;
b) a signal-receiving means,
wherein said signal-receiving means includes at least one indicator means selected from the group consisting of: a light emitting means and a sound emitting means, and wherein said indicator means increases in its intensity as the distance between said wrist band and said signal-receiving means decreases.
